(19) United States
(12) Patent Application Publication
(10) Pub. No.: US 2015/0169820 A1
(43) Pub. Date: Jun. 18, 2015

(54) WEAK POINTS AUTO-CORRECTION PROCESS FOR OPC TAPE-OUT

(71) Applicants: SEMICONDUCTOR MANUFACTURING INTERNATIONAL (BEIJING) CORPORATION, BEIJING (CN); SEMICONDUCTOR MANUFACTURING INTERNATIONAL (SHANGHAI) CORPORATION, SHANGHAI (CN)

(72) Inventor: TIEZHU WANG, Beijing (CN)

(21) Appl. No.: 14/502,986

(22) Filed: Sep. 30, 2014

(30) Foreign Application Priority Data
Dec. 17, 2013 (CN) 201310695777.X

(51) Int. Cl. G06F 17/50

(52) U.S. Cl. CPC G06F 17/5081; G06F 2217/12; G06F 2217/06

(57) ABSTRACT

A method of optical proximity correction includes (a) providing an initial OPC model based on a target design layout, (b) performing a nominal simulation on the initial OPC model, inspecting the simulated OPC model, performing a process window OPC simulation on the inspected OPC model and inspecting the simulated OPC model, (c) determining a presence of weak points. If no weak point is detected, the simulated OPC model is the final OPC model that is used to fabricate a mask. If weak points are detected, making an OPC on the weak points, performing a process window OPC simulation on the corrected weak points, and inspecting the simulation results, repeating the process window OPC simulation and the inspection until all weak points are eliminated, and outputting the final OPC model, and (d) fabricating the mask based on the final OPC model.

### CROSS-REFERENCES TO RELATED APPLICATIONS

The present application claims priority to Chinese patent application no. 201310695777.X, filed with the State Intellectual Office of People's Republic of China on Dec. 17, 2013, the content of which is incorporated herein by reference in its entirety.

### FIELD OF THE INVENTION

The present invention relates to lithographic processing, and more particularly to a method of optical proximity correction of a lithography mask.

### BACKGROUND OF THE INVENTION

With the increase in integration degree of semiconductor devices, patterns required in semiconductor devices shrink in size with each generation of integration. A fundamental trend in the field of integrated circuits is the ever-decreasing reduction of critical feature sizes. Smaller feature sizes enable the increase in density of active devices for a given chip area, resulting in greater functionality and lower manufacturing cost. Smaller features also improve device performance. A critical dimension (CD) for a photolithography process defines a minimum line width, or a contact hole, or the smallest space between two lines or two holes of a masking material that may be patterned by the process.

Optical lithography is a crucial process in semiconductor manufacturing and is one of the most complex manufacturing processes. A photo-mask contains a circuit pattern corresponding to an individual layer of an IC. The pattern is imaged onto a target portion comprising one or more dies on a substrate of a silicon wafer that has been coated with a layer of radiation-sensitive resist material. The patterns used to create a mask are generated utilizing computer-aided design (CAD) programs. CAD programs follow a set of predetermined design rules in order to create functional masks. These rules are set by processing and design limitations. For example, design rules define the space tolerance between circuit devices and interconnect lines, so as to ensure that the devices and lines are placed relative to one another with the design tolerances across process variations. The patterns are then formed on the wafer surface after chemical reactions followed by development, post-exposure bake, wet or dry etching, and measurement and inspection of the etched features. However, the patterns may be optically distorted when imaged onto the wafer surface. If the pattern distortion is not corrected or eliminated, then the lithography process of semiconductor manufacturing may fail. In order to prevent lithographic failures, an optical proximity correction is performed on the photo-mask. Accordingly, before projecting the images of a patterned photo-mask onto the wafer, the photo-mask is first modified or pre-distorted using an optical proximity correction (OPC) to compensate for the distortion caused by the exposure system.

As the number of circuit devices in a given area continues to increase, the shapes reproduced on the substrate and the shapes in the mask become smaller and are placed closer together. The reduction in critical dimension increases the difficulty of faithfully reproducing the image intended by the design layout pattern onto the substrate. The continuous reduction in device dimensions as well in the lithography process window causes variation in the focus and energy of the etching process and leads to pattern defects or weak points. FIG. 1 is a flow chart of a conventional optical proximity correction method 100. Conventional method 100 first begins with a lithography process followed by an optical proximity correction process. Initially, logical operations are performed on a given design pattern (operation 110) , then an OPC process is executed (operation 120). Thereafter, convention method 10 performs a verification of the nominal OPC process and process window OPC processes (operation 130), followed by a inspection process for detecting weak points (operation 140). If no weak point has been detected, then a mask will be fabricated (operation 150). If weak points are present, then the OPC process will be adjusted (operation 160) and reapplied to the OPC operation 120. The steps 120, 130, 140, and 160 will be repeated until there are no more weak points. The conventional method is thus very time consuming with a significant long OPC process duration and low production efficiency.

### BRIEF SUMMARY OF THE INVENTION

Embodiments of the present invention provide a method of optical proximity correction for lithography masks used in the fabrication of material layers of a semiconductor device. A method of optical proximity correction includes the steps of: (a) providing an initial OPC model based on a target design layout, (b) performing a nominal simulation on the initial OPC model, inspecting the simulated OPC model, performing a process window OPC simulation on the inspected OPC model and inspecting the simulated OPC model, (c) determining a presence of weak points. If no weak point is detected, the simulated OPC model is the final OPC model that is used to fabricate a mask. If weak points are detected, making an OPC on the weak points, performing a process window OPC simulation on the corrected weak points, and inspecting the simulation results, repeating the process window OPC simulation and the inspection until all weak points are eliminated, and outputting the final OPC model, and (d) fabricating the mask based on the final OPC model.

In an embodiment, the step (a) may further include the following steps: (a1) collecting data of the target design layout, (a2) performing logical operations based on the collected data and target design layout rules to obtain an operating result, (a3) outputting an OPC model based on the operating result, and (a4) making OPC on the OPC model to obtain the initial model.

In an embodiment, the nominal simulation in step (b) is referred to as a simulation under an ideal condition, where error factors and adverse influence under various process variations in an actual production process are not considered.

In an embodiment, the process window OPC simulation is configured to simulate various factors of an actual production process.

In an embodiment, in the step (c), after making OPC and before performing the process window OPC simulation, the method further includes performing a nominal OPC simulation on the OPC corrected weak points.

In an embodiment, the step (c) further comprises the steps of: (c1) after determining the weak points, making an optical proximity auto-correction on the weak points, (c2) performing a process window OPC simulation on the corrected weak points, (c3) detecting new weak points, in the event that no new weak points are detected: outputting the final OPC model and go to step (d); in the event that new weak points are present: repeating steps (c1) and (c2) until no new weak points are detected.

In an embodiment, the auto-correction design rule is based on the target layout design rule.

In an embodiment, the step (c) may also include, after making the OPC on the weak points, determining whether new weak points are being generated in corresponding locations.

In an embodiment, the method also includes making a new OPC on the new weak points until all new weak points are eliminated.

The following detailed description together with the accompanying drawings will provide a better understanding of the nature and advantages of the present invention.

### BRIEF DESCRIPTION OF THE DRAWINGS

FIG. 1 is a flow chart of a conventional method of an optical proximity correction;

FIG. 2A is a flow chart of a method of an optical proximity correction according to embodiments of the present invention;

FIG. 2B is a more detailed flow chart of FIG. 2A, and

FIGS. 3A through 3D are top views of simulated contours showing different weak points after simulations and optical proximity correction according to embodiments of the present invention.

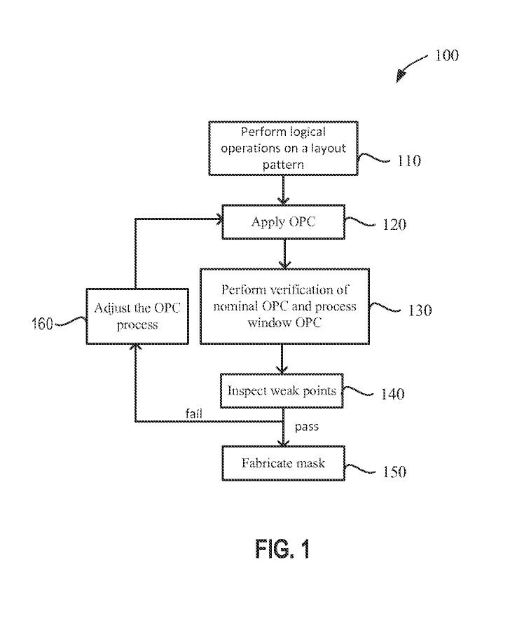

### DETAILED DESCRIPTION OF THE INVENTION

Embodiments of the present invention now will be described more fully hereinafter with reference to the accompanying drawings. The invention may, however, be embodied in many different forms and should not be construed as limited to the embodiments set forth herein. Rather, these embodiments are provided so that this disclosure will be thorough and complete, and will fully convey the scope of the invention to those skilled in the art. The features may not be drawn to scale, some details may be exaggerated relative to other elements for clarity. Like numbers refer to like elements throughout.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including” when used herein, specify the presence of stated features, integers, steps, operations, elements, and/or components, but do not preclude the presence or addition of one or more other features, integers, steps, operations, elements, components, and/or groups thereof.

The invention is defined by the appended claims. This description summarizes aspects to of exemplary embodiments and should not be used to limit the claims. While the invention may be embodied in various forms, there is shown in the drawings and will hereinafter be described some exemplary and non-limiting embodiments, with the understanding that the present disclosure is to be considered an exemplification of the invention and is not intended to limit the invention in the specific embodiments illustrated.

Embodiments of the present invention achieve technical advantages by providing novel methods of making optimized optical proximity correction for lithography masks used in the fabrication of material layers of a semiconductor device. This invention may, however, be embodied in many different forms and should not be construed as limited to the embodiments set forth herein.

The present disclosure provides an optimized OPC method for solving the production inefficiency of the prior art. According to embodiments of the present invention, after performing the OPC process on a design layout and outputting an initial OPC model, the optimized OPC method may include verifying the nominal OPC and the process window OPC and detecting weak points. If no weak points have been detected, a mask will be fabricated based on the OPC model. If the critical dimension is in a non-critical CD area, the method may include first making an optical proximity auto-correction on the target weak points based on the layout design rule and the weak-point OPC rule. The method may further include re-determining positions of the weak points by performing the OPC process and a process window OPC process.

In an embodiment, the OPC is an iteration process. If there are no other types of weak points, the iteration process may correct the weak points very accurately and provide a final result of the corrected weak points to obtain the final OPC model.

In an embodiment, the optical proximity correction (OPC) rule is based on the types of weak-points. The weak point types can be bridges, pinches, coverage of contact holes/vias, and metal bridges for electrical connections.

Further, in accordance with embodiments of the present invention, the method of OPC correction includes the processes of auto-correction and verification of weak points, and through iteratively auto-correction and checking to ensure that the final OPC mask meets the requirements of the target design layout. Because the auto-correction and checking of weak points can be performed independently so that there is no need to go back to the initial OPC model to implement the entire OPC process. Thus, in the absence of weak points, these processes of auto-correction and verification can be omitted. These processes of auto-correction and verification are only required when weak points are present in order to reduce the significant processing time of conventional OPC techniques.

### First Embodiment

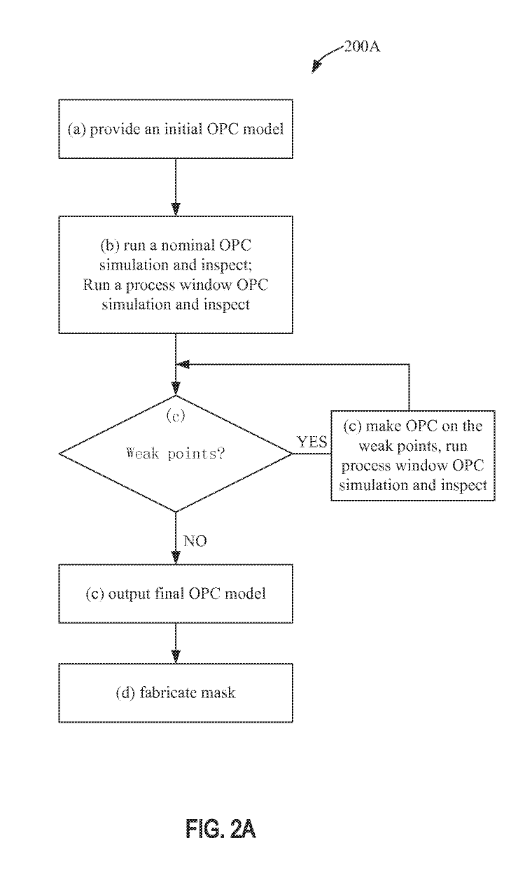

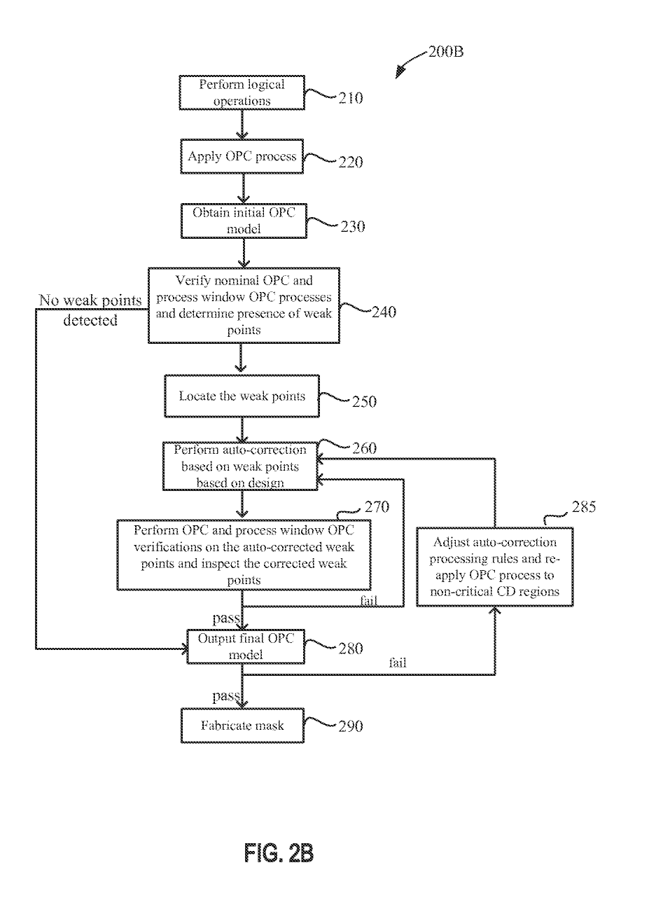

FIG. 2A is a flow chart of a method 200A of fabricating a mask according to embodiments of the present invention. Method 200A may include the steps of:

(a): providing an initial OPC model according to a target design layout;

(b): performing a nominal OPC simulation and inspecting the nominally simulated initial OPC model, and performing a process window OPC on the normal initial OPC model and inspecting the simulation result;

(c): detecting weak points or determining a presence of weak points. If no weak points have been detected, then the initial OPC model is the final OPC model, and the method goes to step (d). If there are weak points present, then the method includes the following processes: making optical proximity auto-correction on the weak points, then performing a nominal OPC simulation and a process window OPC simulation of the auto-corrected weak points, inspecting the simulations results and repeat these processes of auto-correction of the weak points and simulations and inspection until there are no more weak points. The method then generates the final OPC model;

(d): generating a lithography mask using the final OPC model.

FIG. 2B is a more detailed flow chart of FIG. 2A. In an embodiment, step (a) may include performing logical operations according to a target design layout and layout design rules to obtain an initial OPC model. In an embodiment, method 200B includes performing logical operations (block 210) according to a design layout of a provided version and the target design layout to obtain the initial model. Method 200B also includes making OPC on the initial model (block 220) so that the initial model approaches the target design layout. The OPC may include a multitude of processes to obtain the initial OPC model (block 230).

In this process step, the initial OPC model is a simulation model. The initial OPC model may contain one or more weak points after the logical operations have been performed.

In step (b), a simulation is run on the OPC model under normal conditions to obtain a simulated design layout, a verification is performed over the simulated design layout to determine whether or not weak points are present and whether large differences exist between the target design layout and the simulated design layout.

In an embodiment, the simulation run under normal conditions is understood as under conditions where adverse interference of external sources are not considered, e.g., the simulation is run under the optimum condition without taken into consideration of various error factors of an actual production process and effects of various process variables to obtain the simulated design layout. The optimum condition may be the ideal case whereas the actual production process includes effects of errors and process variables. The simulated design layout is consistent with the target design layout.

However, an actual production is inevitably affected by various factors, such as after the OPC model is transferred to the photo-mask and after etching, environmental factors such as vibration may affect the final target design layout. Thus, beside performing a nominal OPC simulation, there is a need to run a process window OPC simulation (block 240). The process window OPC simulation takes various factors into consideration. This method of simulation provides a simulation result that is closer to the practical design layout in order to have a better control of production yield.

Further, in the event that no weak points have been detected by inspection of the simulated OPC model after the nominal and process window OPC simulations, this means that the OPC model meets the requirement and does not need to be optically proximity corrected so that it can be directly used for fabrication of a mask. A lithography process can be performed to transfer the OPC model onto a mask for subsequent processes (block 290).

In the event that weak points are detected by inspection of the simulated OPC model after the nominal and process window OPC simulations, the weak-points will undergo an optical proximity auto-correction process, as described in step (c).

Step (c) may further include the following operations:

Operation C1: after weak points have been detected (block 250), performing an optical proximity auto-correction of weak points according to the target layout design rule (block 260);

Operation C2: performing the nominal OPC simulation and checking the auto-corrected weak points, then performing the process window OPC simulation and inspecting the nominal OPC simulated and checked weak points (block 270);

Operation C3: further determining weak points. If no weak point is detected, then outputting the final OPC model and go to step (d). If one or more weak points are detected, repeat operation C2 until no more weak points are detected.

Operation C3 may further include the following steps:

Step C3-1: If there are still weak points present in Operation C2, then repeat Operation C2 until no weak points are present, then output the final OPC model and go to step (d);

Step C3-2: If there are still weak points present after repeating operation C2, then determine whether the weak points are in the non-critical CD regions (block 285). If the weak points are in the non-core areas, then perform an auto-correction to improve the weak points, then proceed to step (b) until there are no more weak points present.

After eliminating the weak points by auto-correction, operation C3 may include inspecting other areas of the auto-corrected OPC model to ensure that new weak points are not introduced while the weak points are being eliminated by OPC. If new weak points are being introduced during the auto-correction process, then an OPC is made to correct the newly introduced weak points or go back to improve the auto-correction design rule or the target design rules to ensure that the elimination of weak points by auto-correction does not introduce new weak points.

It should be noted that the OPC of weak points is carried out according to the established target layout design rule. If the weak points are not eliminated after repeatedly running operation C2, the target layout design rule may be deficient and must be fixed. According to an embodiment, the method includes fixing the target layout design rule to eliminate the deficiency and to obtain the final OPC model.

In step (d), after receiving the final OPC model, a lithographic photo-mask (also known as reticle) is fabricated. The photo-mask is a “negative” of a photoresist for the lithographic process to project a pattern of the target layout onto a substrate. There is a one-to-one correspondence between the mask pattern and the wafer pattern. The photo-mask generally contains one layer of pattern that is imaged onto the wafer surface.

In an embodiment of the present invention, a method of fabricating a lithographic mask may include: depositing a chromium nitride light-sensitive material of nitrogen chromium oxide to form a chromium based film on a flat and smooth glass substrate (or quartz) by DC magnetron sputtering, then coating a photoresist layer or electron beam resist film uniformly over the chromium based film that is ideal for the production of a photosensitive blank; a lithographic printing process is conducted to transform the original IC layout design into a miniature geometric version of the photo-mask. Thereafter, the photo-mask will be used in the IC production.

### Second Embodiment

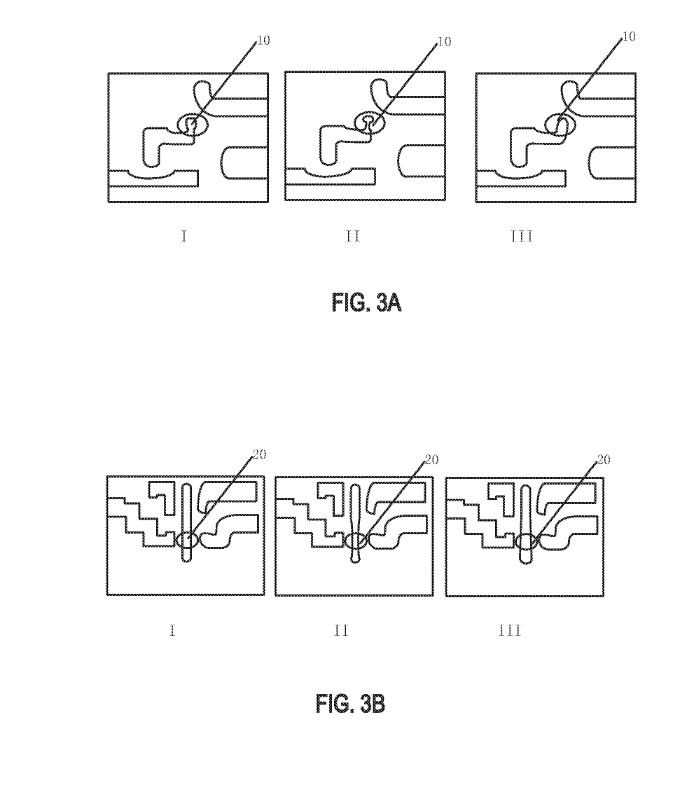

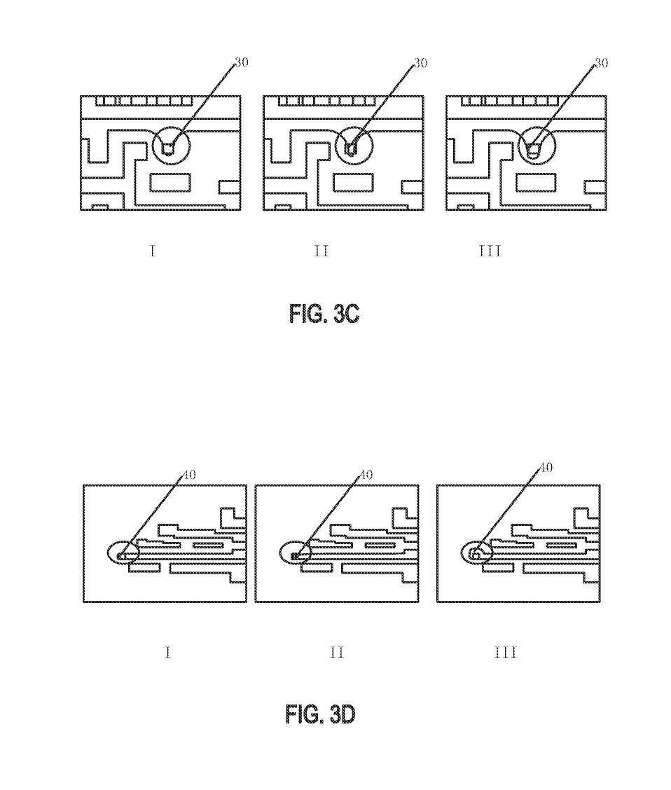

FIG. 3A shows a top view of a pinch as an exemplary weak point 10 to describe a method of repairing the pinch according to a second embodiment of the present invention. It should be understood that the shown layout structure is merely a small portion of a target layout design in order to better illustrate the optical proximity correction of the pinch.

In this embodiment, a method includes performing logical operations on the provided design layout and a target design layout including collecting data of the provided design layout. The method also includes performing logical operations on the target layout to obtain an initial model, and performing an OPC process on the initial model to make it closer to the target layout. The OPC process may include a multitude of processes to arrive at the initial model.

Thereafter, the method performs a nominal simulation on the initial OPC model. The nominal simulation is referred to as a simulation under normal conditions without taking into consideration any adverse external interference. The simulated layout is simulated under the best condition and is closer to the target design layout.

Referring to FIG. 3A-I, a pinch 10 indicated by a circle has to maintain the connection state. A discontinuity of pinch 10 will result in a failure of the target design layout. In FIG. 3A-I, it can be seen that pinch 10 has a good connection.

Thereafter, the method further includes performing a process window OPC simulation. The process window OPC simulation is performed under the consideration of various process factors to obtain a graphic design layout as shown in FIG. 3A-II. As shown, the pinch structure 10 is very unstable with a very narrow interconnect portion that can be easily disconnected. The result of the process window OPC simulation is very close to the actual production. Thus, through the process window OPC simulation the actual production may have a pinch that is prone to rupture, resulting in a reduction in production yield.

Through the process window OPC simulation pinch 10 can be discovered as a weak point in the design layout that needs to be corrected. In an embodiment, the method may include increasing the width at the location of the pinch to ensure an adequate connection of the pinch. In an embodiment, the pinch can be repaired by performing an OPC process on the initial OPC model.

Thereafter, the method may include performing a process window simulation on the auto-corrected OPC model, which is shown in FIG. 3A-III. As can be seen, the thin portion of the pinch 10 that is prone to rupture has been modified to be thicker and more stable relative to the structure before the auto-correction. Therefore, the weak point is eliminated. The auto-corrected OPC model is then used as the final OPC model for the fabrication of a lithographic mask.

### Third Embodiment

FIG. 3B shows a pinch of a layout structure as an exemplary weak point 20 to described a method of repairing the pinch according to a third embodiment of the present invention. It should be noted that the shown layout structure is merely a small portion of a target layout design in order to better illustrate the correction of the pinching.

In this embodiment, the nominal OPC simulation and the process window OPC simulation may be similar to those of the first and second embodiments, and they will not be described in detail herein for the sake of brevity.

In this embodiment, the method includes performing a nominal simulation on the obtained initial OPC model, as shown in FIG. 3B-I. As shown in FIG. 3B-I, pinch 20 does not have a weak point and is consistent with the target design layout. The method then performs a process window OPC simulation of the simulated initial OPC model to obtain a simulated structure as shown in FIG. 3B-II. The method detects that a weak point is present at pinch 20 that has a tapered shape instead of a rectangular bar. The tapered shape may cause etching defects and must be optically proximity auto-corrected. The pinch 20 may be corrected using a OPC process based on the target layout design rule to obtain an auto-corrected OPC model.

The method further includes performing a process window OPC simulation on the auto-corrected OPC model. Through the simulation result the tapered shape may be auto-corrected using the target layout design rule. However, the tapered shape may be over-corrected so that the tapered shape may become so thick that it becomes very close to adjacent lines to cause potential bridging. Thus, the elimination of pinching may cause new weak point problems.

In order to solve this problem, the method according to an embodiment of the present invention provides a reasonable auto-correction design rule. In this embodiment, the auto-correction design rule may increase a dimension of one distal end (the lower end) of pinch 20, and indirectly increase the dimension of the middle portion of pinch 20 to ensure that the middle portion does not shrink while ensuring that the dimension increase of the distal end does not introduce new weak points.

### Fourth Embodiment

FIG. 3C shows a contact coverage layout structure as an exemplary weak point 30 to described a method of repairing the contact coverage according to a fourth embodiment of the present invention. It is understood that the shown layout structure is merely a small portion of a target layout design in order to better illustrate the correction of the pinch.

In this embodiment, the nominal OPC simulation and the process window OPC simulation may be similar to those of the first, second, and third embodiments, and they will not be described in detail herein for the sake of brevity.

In this embodiment, the method includes performing a nominal simulation on the obtained initial OPC model to obtain a simulated pattern, as shown in FIG. 3C-II. FIG. 3C-I shows a weak point in a contact hole 30 as indicated by a circle, contact hole 30 does not have a good coverage of a metal layer overlying contact hole 30. The target design layout requires that the metal layer should have a sufficiently large area to cover contact hole 30 to reduce resistance. As indicated by a process window simulation, the contact coverage has a weak point.

In this embodiment, the weak point is auto-corrected to generate an auto-corrected OPC model, which is further simulated using the process window OPC simulation, resulting in a detection of the weak point. In the event that the weak point cannot be eliminated after a multitude of auto-correction processes has been performed, then the auto-correction design rule will be inspected and modified. The OPC model is resubmitted to the modified OPC design rule for an anew OPC and simulation to obtain a layout pattern as shown in FIG. 3C-III. As can be seen, the weak point is eliminated after the OPC is performed on the OPC model with the modified auto-correction design rule to comply with the requirements of the target design layout.

### Fifth Embodiment

FIG. 3D shows a contact hole/via coverage layout structure as an exemplary weak point 40 to described a method of repairing the contact hole/via coverage according to a fifth embodiment of the present invention. It should be understood that the shown layout structure is merely a small portion of a target layout design in order to better illustrate the correction of the pinching.

In this embodiment, the nominal OPC simulation and the process window OPC simulation may be similar to those of the first, second, third, and fourth embodiments, and they will not be described in detail herein for the sake of brevity.

In this embodiment, the method includes performing a nominal simulation on the obtained initial OPC model to obtain a simulated pattern, as shown in FIG. 3D-I. The simulated pattern does not show the presence of any weak points and is consistent with the target pattern. A process window OPC simulation is then performed on the simulated pattern that shown a weak point 40 in the contact hole/via coverage, highlighted by a circle, as shown in FIG. 3D-II. Contact hole 40 is not completely covered so that the connection resistance increases due to the incomplete coverage of the contact hole. Therefore, an auto-correction based on the target layout design rule and the contact hole correction rule will be required to correct the weak point to obtain a corrected OPC model.

The method further includes performing a process window OPC simulation on the corrected OPC model and determining that the contact hole is completely covered. In an embodiment, although the contact hole is shown to be completely covered, the distance of the contact hole coverage can be too close to adjacent structures that may cause bridging problems.

In order to solve this potential bridging problem, the method may include, during the auto-correction process, removing an area of a side that are close to adjacent structures and increasing a dimension of an area on another side that provides extension space. For example, the upper area of contact hole coverage can be enlarged and the lower area of the contact hole coverage can be reduced to obtain a final OPC model, which is then simulated. The result is that the contact hole has a good coverage while bridging with adjacent structures can be avoided, as shown in FIG. 3D-III.

Embodiments of the present invention provide a method of optical proximity correction that includes an optimized auto-correction process for correcting weak points to reduce the OPC time. The method includes three process steps: (1) modifying target weak points according to the pattern design rule and the auto-correction rule; (2) iteratively performing an OPC simulation and process window OPC simulation to repeatedly determine the weak point positions; (3) automatically correcting the simulated results, outputting the final OPC model, and verifying the final OPC model. According to embodiments of the present invention, the method does not introduce additional processing time if no weak points are present in the design pattern. If weak points are present, the method may use 10 percent of the time relative to those of conventional OPC techniques. Thus, the method according to the present invention provides a significant time savings over conventional OPC processes.

Embodiments of the present invention provide many advantages and benefits. For example, the method requires performing a single OPC process to obtain an OPC model to save time for the entire OPC process. The method requires only 10 percent of OPC process time as compared to the conventional OPC process that requires to re-run the OPC for the entire chip layout. The method can have a wide applicability. In particularly, the method can be used in back-end-of line-process layers.

The steps of a method described in connection with the present disclosure may be embodied directly in hardware, in a software module executed by a processor, or in a combination of the two. A software module may reside in any form of storage medium that is known in the art. A software module may comprise a single instruction or may instructions and may be distributed over several different code segments, among different programs, and across multiple storage modules.

The methods disclosed herein comprise one or more steps for achieving the described method. The method steps may be interchanged with one another without departing from the scope of the claims. In other words, unless a specific order of steps is specified, the order and use of specific steps may be modified without departing from the scope of the claims.

It is to be understood that the above described embodiments are intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A method of fabricating a mask, the method comprising the steps of:
(a) providing an initial OPC model based on a target design layout;
(b) performing a nominal simulation on the initial OPC model and performing a first inspection of the simulated OPC model; performing a first process window OPC simulation on the inspected OPC model and performing a second inspection of the first process window simulated OPC model;
(c) determining a presence of weak points;
in the event that no weak points are present:
making the first process window simulated OPC model as a final OPC model; and
go to (d);
in the event that weak points are present:
making an optical proximity correction (OPC) on the weak points;
performing a second process window OPC simulation on the corrected weak points, and performing a third inspection;
repeating the second process window OPC simulation and the third inspection until no more weak points;
outputting the final OPC model;
(d) fabricating the mask based on the final OPC model.

2. The method of claim 1, wherein the step (a) further comprises the steps of:
(a1) collecting data of the target design layout;
(a2) performing logical operations based on the collected data and target design layout rules to obtain an operating result;
(a3) outputting an OPC model based on the operating result;
(a4) making OPC on the OPC model to obtain the initial model.

3. The method of claim 1, wherein the first and second process window OPC simulations are configured to simulate factors of an actual production process.

4. The method of claim 1, in the step (c), after making the OPC and before performing the second process window OPC simulation, further comprising:
performing a nominal OPC simulation on the corrected weak points.

5. The method of claim 1, the step (c) further comprises the steps of:
(c1) after determining the weak points, making an optical proximity auto-correction on the weak points;
(c2) performing a process window OPC simulation on the corrected weak points;
(c3) detecting new weak points;
in the event that no new weak points are detected:
outputting the final OPC model and go to step (d);
in the event that new weak points are present:
repeating steps (c1) and (c2) until no new weak points are detected.

6. The method of claim 5, wherein the step (c3) further comprises the steps of:
(c3-1) in the event that weak points are detected in the step (c2):
repeating the steps (c1) and (c2);
making an optical proximity auto-correction until no weak points are present;
outputting the final OPC model;
(c3-2) after the optical proximity auto-correction, in the event that weak points are detected:
determining whether the weak points are located in a non-critical CD region;
if the weak points are in the non-critical CD region:
repeating the steps of (c1) and (c2) until no weak points are present.

7. The method of claim 5, wherein the auto-correction design rule is based on the target layout design rule.

8. The method of claim 1, wherein the step (c) further comprises:
after making the OPC on the weak points, determining whether new weak points are generated in corresponding locations.

9. The method of claim 8, wherein, in the event that new weak points are generated, further comprising:
making a new optical proximity auto-correction on the new weak points until the new points are eliminated.
